(19) United States
(12) Patent Application Publication
(10) Pub. No.: US 2026/0074549 A1
(43) Pub. Date: Mar. 12, 2026

(54) BATTERY PACK CHARGER

(71) Applicant: MILWAUKEE ELECTRIC TOOL CORPORATION, Brookfield, WI (US)

(72) Inventor: Logan M. Manderle, Milwaukee, WI (US)

(21) Appl. No.: 19/316,196

(22) Filed: Sep. 2, 2025

Related U.S. Application Data
(60) Provisional application No. 63/691,389, filed on Sep. 6, 2024.

(51) Int. Cl. H02J 7/00; G01P 15/08

(52) U.S. Cl. CPC H02J 7/971; G01P 15/08; H02J 7/485; H02J 7/50; H02J 7/751

(57) ABSTRACT

A device and method for charging a battery pack may include one or more charger terminals configured to connect to corresponding one or more battery pack terminals of a battery pack. The device may include a sensor configured to measure a movement of the charger. The device may include a controller electrically coupled to the sensor and configured to: receive, from the sensor, a movement parameter of the battery pack charger, determine a derating value based on the movement parameter, and modify an amount of current provided to the battery pack over the one or more terminals based on the derating value.

### CROSS-REFERENCE TO RELATED APPLICATIONS

This Application claims priority to U.S. Provisional Patent Application No. 63/691,389 filed on Sep. 6, 2024, which is incorporated by reference herein in its entirety.

### FIELD

The present disclosure relates to battery pack chargers and particularly to battery pack chargers that modify the charging current based on vibration.

### BACKGROUND

Chargers may be used to charge rechargeable battery packs for various applications including power tool battery packs.

### SUMMARY

The present disclosure provides, in one aspect, a battery pack charger for charging during transport.

In some aspects, the disclosure herein relates to a battery pack charger comprising one or more charger terminals configured to connect to corresponding one or more battery pack terminals of a battery pack; a sensor configured to measure a movement of the charger; and a controller electrically coupled to the sensor and configured to receive, from the sensor, a movement parameter of the battery pack charger, determine a derating value based on the movement parameter, and modify an amount of current provided to the battery pack over the one or more terminals based on the derating value.

In some aspects, the disclosure herein relates a method of charging a battery pack with a battery pack charger, the method comprising receiving, from a sensor at a controller of the battery pack charger, a movement parameter of the battery pack charger; determining, using the controller, a derating value based on the movement parameter; and modifying, using the controller, an amount of current provided to the battery pack based on the derating value.

Other features and aspects of the disclosure will become apparent by consideration of the following detailed description and accompanying drawings.

### BRIEF DESCRIPTION OF THE DRAWINGS

FIG. 1 is a schematic of a battery charging system mounted within a transportation vehicle according to an aspect of the disclosure herein.

FIG. 2 is a schematic of the battery charging system from FIG. 1 according to some aspects of the disclosure herein.

FIG. 3 illustrates a control system for the battery charging system according to an aspect of the disclosure herein.

FIG. 4 illustrates a regression model as one method for determining a derating value for the control system from FIG. 3.

FIG. 5 illustrates a vibration classification as another method for determining a derating value for the control system from FIG. 3.

FIG. 6 is a flow chart for a method of charging a battery pack with a charger according to some aspects of the disclosure herein.

Before any embodiments of the disclosure are explained in detail, it is to be understood that the disclosure is not limited in its application to the details of construction and the arrangement of components set forth in the following description or illustrated in the following drawings. The disclosure is capable of other embodiments and of being practiced or of being carried out in various ways. Also, it is to be understood that the phraseology and terminology used herein is for the purpose of description and should not be regarded as limiting.

The use of “including,” “comprising,” or “having” and variations thereof are meant to encompass the items listed thereafter and equivalents thereof as well as additional items. Unless specified or limited otherwise, the terms “mounted,” “connected,” “supported,” and “coupled” and variations thereof are used broadly and encompass both direct and indirect mountings, connections, supports, and couplings.

Unless the context of their usage unambiguously indicates otherwise, the articles “a,” “an,” and “the” should not be interpreted as meaning “one” or “only one.” Rather these articles should be interpreted as meaning “at least one” or “one or more.” Likewise, when the terms “the” or “said” are used to refer to a noun previously introduced by the indefinite article “a” or “an,” “the” and “said” mean “at least one” or “one or more” unless the usage unambiguously indicates otherwise.

In addition, it should be understood that embodiments may include hardware, software, and electronic components or modules that, for purposes of discussion, may be illustrated and described as if the majority of the components were implemented solely in hardware. However, one of ordinary skill in the art, and based on a reading of this detailed description, would recognize that, in at least one embodiment, the electronic-based aspects may be implemented in software (e.g., stored on non-transitory computer-readable medium) executable by one or more processing units, such as a microprocessor and/or application specific integrated circuits (“ASICs”). As such, it should be noted that a plurality of hardware and software-based devices, as well as a plurality of different structural components, may be utilized to implement the embodiments. For example, “servers,” “computing devices,” “controllers,” “processors,” etc., described in the specification can include one or more processing units, one or more computer-readable medium modules, one or more input/output interfaces, and various connections (e.g., a system bus) connecting the components.

Relative terminology, such as, for example, “about,” “approximately,” “substantially,” etc., used in connection with a quantity or condition would be understood by those of ordinary skill to be inclusive of the stated value and has the meaning dictated by the context (e.g., the term includes at least the degree of error associated with the measurement accuracy, tolerances [e.g., manufacturing, assembly, use, etc.] associated with the particular value, etc.). Such terminology should also be considered as disclosing the range defined by the absolute values of the two endpoints. For example, the expression “from about 2 to about 4” also discloses the range “from 2 to 4”. The relative terminology may refer to plus or minus a percentage (e.g., 1%, 5%, 10%, or more) of an indicated value.

It should be understood that although certain drawings illustrate hardware and software located within particular devices, these depictions are for illustrative purposes only. Functionality described herein as being performed by one component may be performed by multiple components in a distributed manner. Likewise, functionality performed by multiple components may be consolidated and performed by a single component. In some embodiments, the illustrated components may be combined or divided into separate software, firmware and/or hardware. For example, instead of being located within and performed by a single electronic processor, logic and processing may be distributed among multiple electronic processors. Regardless of how they are combined or divided, hardware and software components may be located on the same computing device or may be distributed among different computing devices connected by one or more networks or other suitable communication links. Similarly, a component described as performing particular functionality may also perform additional functionality not described herein. For example, a device or structure that is “configured” in a certain way is configured in at least that way but may also be configured in ways that are not explicitly listed.

Accordingly, in the claims, if an apparatus, method, or system is claimed, for example, as including a controller, control unit, electronic processor, computing device, logic element, module, memory module, communication channel or network, or other element configured in a certain manner, for example, to perform multiple functions, the claim or claim element should be interpreted as meaning one or more of such elements where any one of the one or more elements is configured as claimed, for example, to make any one or more of the recited multiple functions, such that the one or more elements, as a set, perform the multiple functions collectively.

Other aspects of the embodiments will become apparent by consideration of the detailed description and accompanying drawings.

### DETAILED DESCRIPTION

Charging batteries during transportation is useful in any industry where tool transport is needed. Decreasing the amount of time required to charge a battery requires an increase in current. As higher currents are used to charge batteries, an increase in temperature at the terminal also occurs. During transportation, vibrations can further increase the terminal temperatures. In order to mitigate this issue, the power may be derated, and in turn the current received at the battery decreases, based on measured movement parameters proximate the battery.

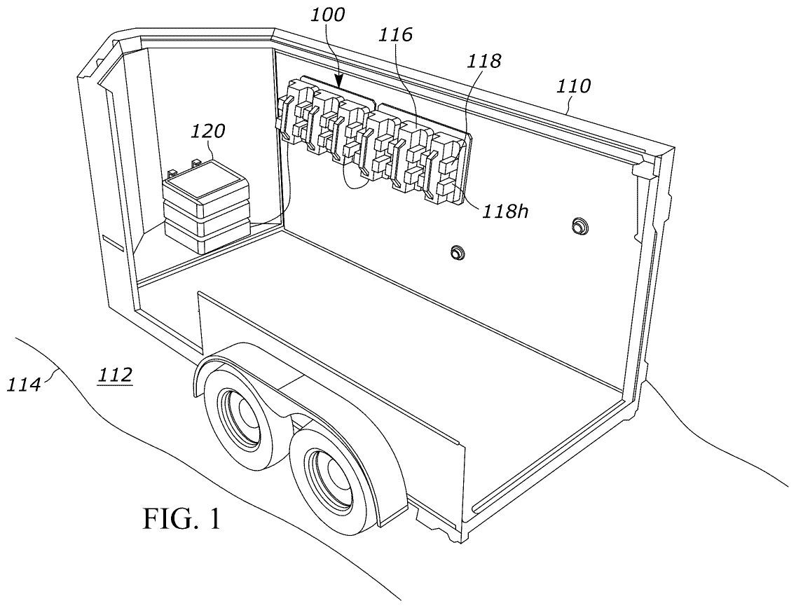

With reference to FIG. 1, a battery charging system 100 is mounted within a transportation vehicle, by way of example a trailer 110, traveling on a terrain 112 having a variable smoothness 114. The battery charging system 100 may include several battery pack chargers 116 each operable to charge a battery pack 118. The battery charging system 100 may be configured to charge different types of battery packs 118. At least one battery pack 118 may be a high output battery pack 118h (e.g., having a current capacity of 12 amp-hours (Ah) or more), which requires about 3 times the power of typical chargers, in about 60 minutes. The battery charging system 100 may be connected to a power source 120.

Each battery pack 118, 118h is connectable to and operable for powering various motorized power tools (e.g., a cut-off saw, a miter saw, a table saw, a core drill, an auger, a breaker, a demolition hammer, a compactor, a vibrator, a compressor, a drain cleaner, a welder, a cable tugger, a pump, etc.), outdoor tools (e.g., a chain saw, a string trimmer, a hedge trimmer, a blower, a lawn mower, etc.), other motorized devices (e.g., vehicles, utility carts, a material handling cart, etc.), and non-motorized electrical devices (e.g., a power supply, a light, an AC/DC adapter, a generator, etc.). The battery pack 118 is, for example, a Lithium-ion chemistry-based power tool battery pack having a nominal voltage of about 18 Volts. The battery pack 118h may have a nominal voltage of about 36 Volts, 48 Volts, 72 Volts, or the like.

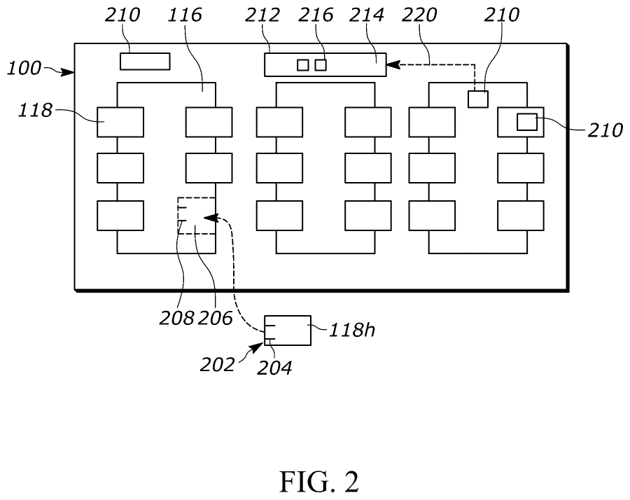

FIG. 2 is a schematic of the battery charging system 100. Each battery pack 118, 118h includes a battery pack interface 202 including battery terminals 204. Each battery pack charger 116 includes a corresponding charger interface 206 with charger terminals 208. In one aspect the battery pack 118 is slidably receivable (illustrated by dashed arrow) at the battery pack interface 202 to the charger interface to connect the battery terminals 204 to the charger terminals 208. While a slideable interface is illustrated, any type of interface capable of electrically connecting the battery pack 118 to the battery pack charger 116 is contemplated.

The battery charging system 100 may include a motion sensor 210. The motion sensor 210 may be an accelerometer, an inertial measurement unit (IMU), a piezo vibration sensor, or some other motion measurement device. The motion sensor 210 may be located anywhere in the battery charging system 100 including within the battery pack charger 116. Any number of motion sensors 210 are contemplated. In one aspect, each battery pack charger 116 may have a dedicated motion sensor 210. It is further contemplated that the battery pack 118 includes a motion sensor 210.

The battery charging system 100 may further include a control system 212 for interacting with and controlling the battery charging system 100. The control system 212 may include a display 214 with user inputs 216 for a user to interact with the battery charging system 100.

As the trailer 110 moves, a movement parameter 220 sensed by the motion sensor 210 may be collected and sent to the control system 212. The movement parameter 220 may include data corresponding with an amount of vibration experienced by the battery charging system 100. The amount of vibration depends on and is correlated with the amount of smoothness 114 of the terrain 112 over which the trailer 110 is traveling.

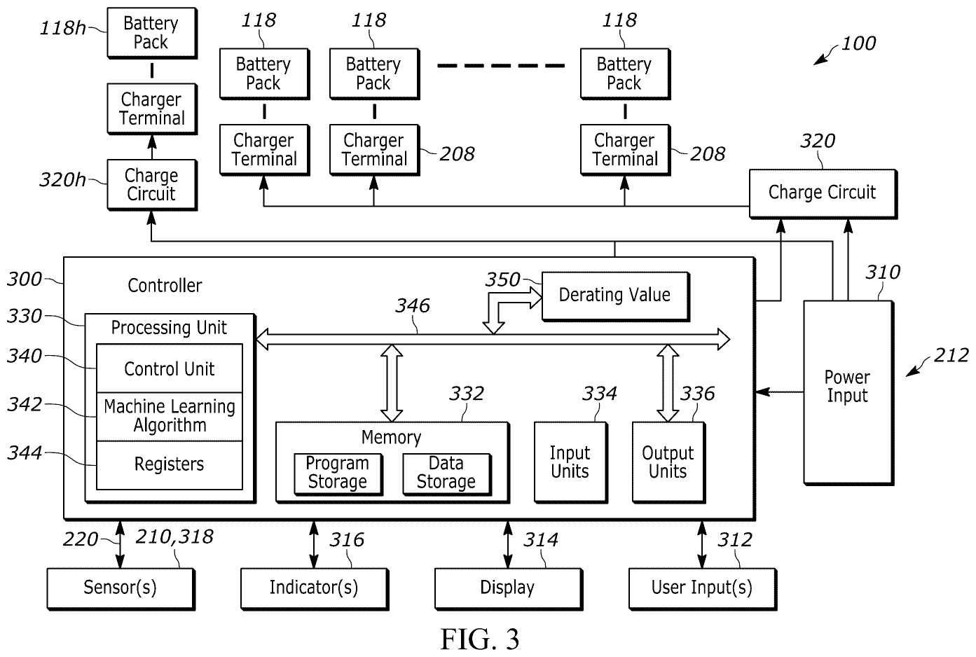

FIG. 3 illustrates the control system 212 for the battery charging system 100 according to one aspect of the disclosure herein. The control system 212 may include a controller 300. The controller 300 may be electrically and/or communicatively connected to a variety of components of the battery charging system 100. The connection may be wireless or wired. In some aspects, the control system 212 may receive wireless inputs from an application running on an external device (e. g, a smartphone, a tablet, a laptop computer, or the like). The controller 300 may be connected to a power input 310, one or more user inputs 312, a display 314, one or more indicators 316, one or more sensors 318, and a charge circuit 320.

The controller 300 may include combinations of hardware and software that are operable to, among other things, control the operation of the battery charging system 100, monitor the operation of the battery charging system 100, activate the one or more indicators 316, sense current being drawn by the battery charging system 100, and control an amount of current conducted by the charger terminals 208.

The controller 300 may include a plurality of electrical and electronic components that provide power, operational control, and protection to the components within the controller 300 and/or the battery charging system 100. For example, the controller 300 includes, among other things, a processing unit 330 (e.g., a microprocessor, a microcontroller, or another suitable programmable device referred to as an electronic processor), a memory 332, input units 334, and output units 336. The processing unit 330 includes, among other things, a control unit 340, a machine learning algorithm 342, and a plurality of registers 344 (shown as a group of registers in FIG. 3) and is implemented using a known computer architecture (e.g., a modified Harvard architecture, a von Neumann architecture, etc.). The processing unit 330, the memory 332, the input units 334, and the output units 336, as well as the various components or circuits connected to the controller 300 are connected by one or more control and/or data buses (e.g., common bus 346). The control and/or data buses are shown generally in FIG. 3 for illustrative purposes. The use of one or more control and/or data buses for the interconnection between and communication among the various modules, circuits, and components would be known to a person skilled in the art.

The memory 332 may be a non-transitory computer readable medium and includes, for example, a program storage area and a data storage area. The program storage area and the data storage area can include combinations of different types of memory, such as a ROM, a RAM (e.g., DRAM, SDRAM, etc.), EEPROM, flash memory, a hard disk, an SD card, or other suitable magnetic, optical, physical, or electronic memory devices. The processing unit 330 is connected to the memory 332 and executes software instructions that are capable of being stored in a RAM of the memory 332 (e.g., during execution), a ROM of the memory 332 (e.g., on a generally permanent basis), or another non-transitory computer readable medium such as another memory or a disc. Software included in the implementation of the battery charging system 100 may be stored in the memory 332 of the controller 300. The software may include, for example, firmware, one or more applications, program data, filters, rules, one or more program modules, and other executable instructions. The controller 300 is configured to retrieve from the memory 332 and execute, among other things, instructions related to the control processes and methods described herein. In other constructions, the controller 300 includes additional, fewer, or different components.

The one or more input units 334 may be operably coupled to the controller 300 to, for example, turn the battery charging system 100 on or off. In some embodiments, the one or more input units 334 may include a combination of digital and analog input or output devices required to achieve a desired level of operation for the battery charging station, such as one or more knobs, one or more dials, one or more switches, one or more buttons, etc. In some embodiments, the one or more input units 334 may receive signals wirelessly from a device external to the battery charging system 100 (e.g., a user's mobile phone).

The power input 310 includes an interface to connected to a power source 120. In one example, the power input 310 includes a power cord interface to receive a power cord that may be connected to a wall outlet or an external power generator. In some examples, the power input 310 may include a connection to a vehicle power system, solar panels, or the like. The one or more user inputs 312 include, for example, the user inputs 216 (shown in FIG. 2). The display 314 includes, for example the display 214 (shown in FIG. 2).

The indicators 316 include, for example, one or more light-emitting diodes (“LEDs”). The indicators 316 may be configured to display conditions of, or information associated with, the battery charging system 100. For example, the indicators 316 are configured to indicate measured electrical characteristics of the battery charging system 100, the status of the battery charging system 100, the status of an amount of remaining charge for the battery packs 118, 118h, etc. The one or more sensors 318 include, for example, the motion sensor 210, a temperature sensor, a current sensor, a voltage sensor, and/or the like. The one or more sensors 318 measure various parameters of the battery charging system 100 and provide a signal corresponding to the measured parameter to the controller 300 for processing.

The charge circuit 320 is electrically connected between the power input 310 and the one or more charger terminals 208. The charge circuit 320 is controlled by the controller 300. The charge circuit 320 is used to adjust the amount of current to the charger terminals 208 and in turn the battery packs 118, 118h. In one example, the charge circuit 320 may include a single charge circuit 320 located between the power input 310 and multiple charger terminals 208 to control the amount of current conducted to all charger terminals 208 at once. In another example, each charger terminal 208 may have a dedicated charge circuit 320. In yet another example, multiple charge circuits 320 may be provided with each charge circuit 320 controlling the amount of current conducted to one or more charger terminals 208. In one example, a separate charge circuit 320h may be provide for controlling current conducted to a charger terminal 208 associated with the high output battery pack 118h.

In one example, the charge circuit 320 includes a semiconductor switch, for example, a field effect transistor (FET), a bipolar junction transistor, or the like. The controller 300 provide pulse-width modulated (PWM) signals to the charge circuit 320 to control the amount of current flowing between the power input 310 and the charger terminals 208. A gate driver maybe connected between the controller 300 and the charge circuit 320 in these examples. In another example, the charge circuit 320 includes a variable resistor, a switchable resistor, or other circuit that can be used to adjust the resistance or switch in and out resistors into the current path to adjust the amount of current flowing through the current path between the power input 310 and the charger terminals 208. The controller 300 determines a derating value 350 based on a movement parameter 220 collected by the motion sensor 210. The controller 300 controls the charge circuit 320 based on the derating value 350. For example, the controller 300 adjusts the duty ratio of the PWM signals provided to the semiconductor switch, adjust the resistance of the current path, and the like to modify the amount of current flowing in the current path.

As previously discussed, during transportation, vibrations may cause an increase in temperature at the battery terminals 204 and the charger terminals 208. In one aspect the amount of current provided at the charger terminals 208 may be changed based on the movement parameter 220 detected by the motion sensor 210. The processing unit 330 may measure the movement parameter 220 in the form of linear and angular acceleration. The linear and angular acceleration data are used to compute the amount of vibration, e.g., frequency values, or a state of the amount of smoothness 114 using, for example, a pre-populated mapping, a pre-trained machine learning model, or the like. The derating value 350 is determined based on the amount of vibration and/or vibration state. For example, a vibration amount of 10 may be translated into a derating value of 0.95 which is used to control the charge circuit 320 to decrease, by 5%, the amount of current provided to the charger terminals 208. For example, the controller 300 may reduce the duty ratio of the PWM signals provided to the charge circuit 320 to 95%.

In some embodiments, the battery charging system 100 includes one or more vents, one or more fans (not shown) and one or more temperature sensors for controlling the temperature of the battery charging system 100. For example, the one or more sensors 318 include a temperature sensor used to measure an internal temperature of the battery charging system 100. When the temperature is too high or reaches one or more threshold temperature values, the controller 300 operates one or more fans to circulate air to reduce the temperature of the battery charging system 100. In some embodiments, a switch (not shown) is provided between the power input 310 and the charge circuit(s) 320 for shutting off power during a high temperature event.

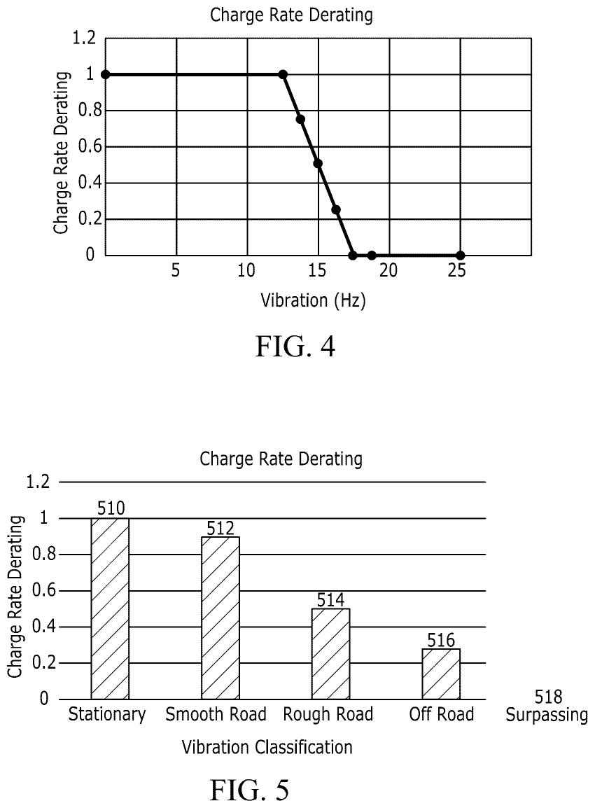

Translating the vibration amount to a derating value 350 may be performed in multiple ways. FIG. 4 illustrates a regression model as one method of determining the derating value 350. Applying the regression model to the amount of vibration can include calculating the derating value 350 based on a slope of, in this example, a linear regression. In one aspect the vibration amount is associated with a specific derating value. The vibration amount may be measured in frequency (Hz), displacement (m), acceleration (g's), or any combination of measurements, for example g²/Hz or GRMS. For purposes of explanation, the vibration values described herein quantify a relative amount of vibration where 0 is no vibration and 25 is a large amount of vibration.

As is illustrated, vibration values from 0 to 12.5 are associated with a derating value of 1. In this case nothing is changed and the battery pack 118 may be charged at a max charge rate, for example 18 A. As the vibration amount increases to between 12.5 and 17.5, the derating value decreases at a constant rate. In this example a 20% increase in the vibration reading from 12.5 to a 15, equates to a 0.5 derating value which computes to 9A of current.

Further, anything beyond 17.5 equates with a derating value of zero, meaning the current amount provided to the charging terminals is zero (0 A) for vibration levels beyond 17.5.

FIG. 5 illustrates assigning a vibration classification as another method of determining the derating value 350. For example, a minimum vibration classification 510 may equate to vibration values of less than 13 and be associated with a derating value of 1.

As noted above, a derating value of 1 is where nothing is changed and the battery pack 118 may be charged at a max charge rate, for example 18 A. A low vibration classification 512 may equate to vibration values of between 13 and 15 and be associated with derating values of between 0.60 and 1.0, or a single derating value, by way of example 0.90. A medium vibration classification 514 may equate to vibration values of between 15 and 17 and be associated with derating values of between 0.30 and 0.60, or a single derating value, by way of example 0.50. A high vibration classification 516 may equate to vibration values of between 17 and 20 and may be associated with a derating value of between 0.0 and 0.30, or a single derating value, by way of example 0.25. In one aspect a vibration reading is associated with a vibration classification, which is correlated to, for example, the amount of smoothness 114 of the road. The minimum vibration classification 510 may be a stationary category, the low vibration classification 512 a smooth road category, the medium vibration classification 514 a rough road category, and the high vibration classification 516 an off-road category. Further, a surpassing vibration classification 518, may equate to vibration values of anything beyond 20 and be associated with a derating value of 0 where the current supply is shut off (0 A).

While FIG. 4 and FIG. 5 illustrate possible methods for determining the derating value, these are merely examples and should not be considered limiting. The actual derating value could be different. For example, a derating curve may be used to determine a slope at a given point instead of a regression model as is illustrated in FIG. 4 or additional or different classifications other than those illustrated in FIG. 5 along with other ranges may be utilized for vibration classification.

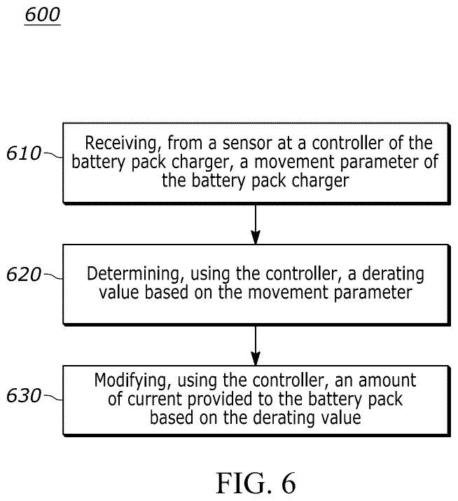

FIG. 6 is a flow chart for a method 600 of charging a battery pack, e.g., battery pack 118, with a battery pack charger, e.g., the battery pack charger 116. The method 600 may be performed by, for example, the battery charging system 100. Additionally, the steps provided within FIG. 6 are merely examples, and may instead be conducted in a different order or simultaneously.

At block 610, the method 600 includes receiving, using the one or more sensors 318, a movement parameter of the battery pack charger 116. The one or more sensors 318 (e.g., motion sensor 210) measures movement of the battery pack charger 116. For example, the motion sensor 210 may detect vibrations, rotation, or the like of the battery pack charger 116. In one example, the motion sensor 210 is a 9-axis inertial measurement unit (IMU) that measures acceleration, orientation, gravitational forces, and the like acting on the battery pack charger 116. The controller 300 receives a measurement signal from the one or more sensors 318. The measurement signal includes a movement parameter corresponding to the battery pack charger 116. The one or more sensors 318 may output a continuous measurement signal continuously updating the movement parameter based on the measurements. In one example, the one or more sensors 318 provide the measurement signal (i.e., the movement parameter) at discrete intervals.

At block 620, the method includes determining, using the controller 300, a derating value 350 based on the movement parameter. The derating value 350 can be determined from the movement parameter using any of the models described above with respect to FIGS. 4 and 5. By way of example, using the machine language algorithm, to compute the linear and angular acceleration measurements into a frequency amount from, e.g., from 0 to 25. The classification may mean equating a specific output frequency with a specific numeral, e.g., 15 equates to a derating value of 0.5. Classifying may also include categorizing a specified range, e.g., 15-20, with the high vibration classification 516, or “off road”, classification.

At block 630, the method includes modifying, using the controller 300, an amount of current provided to the battery pack over the one or more terminals based on the derating value 350. For example, the controller 300 controls a duty ratio of the PWM signal provided to the charge circuit 320. By way of example, the medium vibration classification 514 derating value is 0.5. Modifying the max charge rate in this exemplary case would mean decreasing the amount of current conducted to the charger terminals 208 by half or conducting 9 A to the charging terminals.

Although detailed description is provided with reference to certain preferred embodiments, variations and modifications exist within the scope and spirit of one or more independent aspects described herein.

What is claimed is:

1. A battery pack charger comprising:
one or more charger terminals configured to connect to corresponding one or more battery pack terminals of a battery pack;
a sensor configured to measure a movement of the battery pack charger; and
a controller electrically coupled to the sensor and configured to:
receive, from the sensor, a movement parameter of the battery pack charger,
determine a derating value based on the movement parameter, and
modify an amount of current provided to the battery pack over the one or more charger terminals based on the derating value.

2. The battery pack charger of claim 1, further comprising:
a power input; and
a charge circuit electrically connected between the power input and the one or more charger terminals, wherein the controller is electrically coupled to the charge circuit and configured to control, using the charge circuit, the amount of current conducted between the power input and the one or more charger terminals.

3. The battery pack charger of claim 1, wherein the sensor is an inertial measurement unit configured to measure linear and angular acceleration as the movement parameter.

4. The battery pack charger of claim 3, wherein the controller is configured to determine an amount of vibration based on the linear and angular acceleration.

5. The battery pack charger of claim 4, wherein the controller is configured to determine the derating value based on a regression model applied to the amount of vibration.

6. The battery pack charger of claim 5, wherein the controller is configured to determine the derating value based on a slope of the regression model.

7. The battery pack charger of claim 4, wherein the controller is configured to:
determine a vibration classification based on the amount of vibration; and
determine the derating value based on the vibration classification.

8. The battery pack charger of claim 1, wherein the movement parameter includes data corresponding to an amount of vibration experienced by the battery pack charger.

9. A method of charging a battery pack with a battery pack charger, the method comprising:
receiving, from a sensor at a controller of the battery pack charger, a movement parameter of the battery pack charger;
determining, using the controller, a derating value based on the movement parameter; and
modifying, using the controller, an amount of current provided to the battery pack based on the derating value.

10. The method of claim 9, further comprising:
measuring, using the sensor, linear and angular acceleration as the movement parameter; and
determining the amount of vibration based on the linear and angular acceleration.

11. The method of claim 10, further comprising determining, using the controller, the derating value by applying a regression model to the amount of vibration.

12. The method of claim 10, further comprising assigning, using the controller, a vibration classification associated with the amount of vibration.

13. The method of claim 12, further comprising determining, using the controller, the derating value based on the vibration classification.

14. The method of claim 13, wherein the vibration classification is one of a low vibration classification, medium vibration classification, and high vibration classification.

15. The method of claim 9, further comprising controlling, using a charge circuit electrically coupled to the controller, the amount of current provided to the battery pack.

16. A battery pack charging system comprising:
a first charger configured to receive a first type of battery pack;
a second charger configured to receive a second type of battery pack;
a sensor configured to measure a movement of the battery pack charging system; and
a controller electrically coupled to the sensor and configured to:
receive, from the sensor, a movement parameter of the battery pack charging system,
determine a derating value based on the movement parameter, and
modify an amount of charging current provided via the first charger and the second charger based on the derating value.

17. The battery pack charging system of claim 16, wherein the sensor is an inertial measurement unit configured to measure linear and angular acceleration as the movement parameter.

18. The battery pack charging system of claim 17, wherein the controller is configured to determine an amount of vibration based on the linear and angular acceleration.

19. The battery pack charging system of claim 18, wherein the controller is configured to determine the derating value based on a slope a regression model applied to the amount of vibration.

20. The battery pack charging system of claim 18, wherein the controller is configured to:
determine a vibration classification based on the amount of vibration; and
determine the derating value based on the vibration classification.
